(19) United States
(12) Patent Application Publication
(10) Pub. No.: US 2002/0138615 A1
(43) Pub. Date: Sep. 26, 2002

(54) System and method for device management through world wide web confederacy

(76) Inventor: Garth F. Schmeling, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/814,303

(22) Filed: Mar. 21, 2001

(51) Int. Cl. G06F 15/16; G06F 15/173

(52) U.S. Cl. 709/225; 709/218

(57) ABSTRACT

A system and method for creating a confederacy of the present invention. The inventive system includes a network and a plurality of devices coupled thereto, with at least one of the devices having a resource to which access is desired. In accordance with the invention, an agent is provided on at least one of the devices for automatically effecting communication with respect to the resource between the device having the resource and at least one of the other devices coupled to the network. In the illustrative application, the network is an intranet, the resource is embedded web content and an agent resides on each device connected to the network. The agents implement code for establishing and maintaining the confederacy. For example, the agents allow for new devices to join the confederacy, provide a consistent view of embedded web content, cache an object value from a device in the confederacy, allow each member to act as a portal, monitor changes at the other devices in the confederacy, verify that a member device is active and in the confederacy and perform other functions.

### BACKGROUND OF THE INVENTION

1. Field of Invention

This invention relates to computing systems and networks therefor. Specifically, the present invention relates to systems and methods for managing printers and other devices connected via a network.

2. Description of the Related Art

There are currently a number of networks (i.e., private internal networks or “intranets”) having a small number of devices (computers, printers, etc.) attached thereto. Many of these devices have embedded web, i.e. World Wide Web, content. Currently, a network administrator must either install device management software on a client machine or individually access each device and browse the web content therein to perform a number of routine functions such as changing the configuration of the device, checking status, upgrading software, troubleshooting, etc.

However, for many reasons, it may not be practical or desirable to install network administration software on a given client machine. In addition, it has not been efficient to individually access each machine for such routine administrative tasks, especially in view of the accessibility of the managed devices via the network.

Hence, there is a need in the art for a system or method for allowing management of devices connected to a network without requiring an installation of management software on a client machine or individual access of each device to browse the web content therein.

### SUMMARY OF THE INVENTION

The need in the art is addressed by the system and method for creating a confederacy of the present invention. The inventive system includes a network and a plurality of devices coupled thereto, with at least one of the devices having a resource to which access is desired. In accordance with the invention, an agent is provided on at least one of the devices for automatically effecting communication with respect to the resource between the device having the resource and at least one of the other devices coupled to the network.

In the illustrative application, the network is an intranet, the resource is embedded web content and an agent resides on each device connected to the network. The agents implement code for establishing and maintaining the confederacy. For example, the agents allow for new devices to join the confederacy, provide a consistent view of embedded web content, cache an object value from a device in the confederacy, allow each member to act as a portal, monitor changes at the other devices in the confederacy, verify that a member device is active and in the confederacy and perform other functions.

More particularly, the present invention provides a method for devices to join a confederacy by which members may indicate that they have embedded content or other resources of interest. The confederacy indicates to users which devices do and do not have embedded content. It allows users to browse to any one device in the confederacy and for that device to act as a portal to all the other devices in the confederacy. This allows users to easily browse to any one of them. Further, the confederacy indicates that content is available in each device and it indicates which objects are available. Additions, deletions or changes to objects in a device are automatically communicated to the confederacy and are available to the user. If a device goes down, it is removed from the confederacy after a time-out period.

Within the confederacy of devices, each device simultaneously performs two roles, as a “monitoring device” and as a “monitored device”. As a monitoring device, the device tracks changes in the presence or absence of other devices and in changes in their embedded web content objects. As a monitored device, the device informs monitoring devices about changes in the monitored device's objects.

To create the confederacy of web-enabled devices, the following steps are executed. A new device when it is first brought up on the network announces its presence by sending a message to the “Confederacy” multicast address. It then permanently listens for other announcements on that address. If there are no other members, this establishes the confederacy. If the confederacy has already been established, all other members will send unicast replies to the new device. These replies establish communication between the new device and the existing members. With each established member, the new device will query the member for existing web content names and their associated Uniform Resource Locators (URLs) and be queried by it for the same information. Further, it will establish reciprocal monitoring relationships with the member so that each can monitor changes in the web content of the other.

To create a consistent view of all embedded web content in all members in the confederacy the following steps are executed. Each member, when it joins the confederacy, establishes a relationship with each other member. It queries each member for the embedded web content object names that it has and for the URLs of those objects. It then adds the member to its list of members and for each, adds its object names and URLs. It represents these in a hierarchical manner to the user. Established members do the same thing for the new member. By default, members do not cache values for objects. They simply store object names and URLs

Optionally, more capable devices, with faster processors and larger capacity to store data, could retrieve values for objects and cache them. This would speed up object access time. When a change command is received or an object times out, the new value would again have to be retrieved.

By representing the members and their embedded web objects in a hierarchical manner, each member can act as a portal for all other members. A user may browse to one member and have access to all other members.

Each member, when it joins the confederacy, establishes a relationship with each other member. It exchanges embedded web content object names and URLs with it. Further, it establishes a reciprocal monitoring relationship with the other member. Each member has a monitoring role and a monitored role. This monitoring relationship is established with the command, ‘set monitor’ <Device ID>. The monitored device will add the device ID of the monitoring device to its monitor table along with a monitor duration. This duration will tell it how long to send changes to the monitoring device. It will also send an acknowledgment to the monitoring device that includes the duration. The monitoring device must reinitialize the monitor relationship before the duration expires.

In its monitored role, every time a new object is added to its web content, the device sends to each other member that is monitoring it a ‘set addition’ <Object Name> <URL>″ command. Every time an object is deleted from its embedded web content, the device sends to each other member that is monitoring it a ‘set deletion’ <Object Name> <URL>″ command. Every time there is a change to an object in its embedded web content, the device sends to each other member that is monitoring it a ‘set change’<Object Name> <New URL>″ command. For each of these SET commands, the monitoring device sends an ‘acknowledge set’ command back to the monitored device.

If a device fails to acknowledge a SET command or a MONITOR command or fails to re-initialize its monitor relationship, a “ping” will be sent to it to determine if it is still alive. If it fails to respond to a predetermined number of successive pings (e.g. three), it will be removed from the list of members. In this manner, devices that are no longer on the network are removed from the confederacy.

### BRIEF DESCRIPTION OF THE DRAWINGS

FIG. 1 is a block diagram of a system incorporating the teachings of the present invention.

FIG. 2 is a generalized software block diagram for use with the system of FIG. 1 in accordance with the teachings of the present invention.

FIG. 3 is a message flow diagram showing the establishment of the confederacy in accordance with the teachings of the present invention.

FIG. 4 is a message flow diagram illustrating a manner by which a device joins the confederacy in accordance with the teachings of the present invention.

FIG. 5 is a message flow diagram showing how a consistent view of data stored on the network devices is created in accordance with the teachings of the present invention.

FIG. 6 is a message flow diagram illustrating the manner by which the confederacy allows members to monitor changes in other member's content.

FIG. 7 is a message flow diagram showing how a monitored device in the confederacy indicates that a change in its stored data has occurred in accordance with the teachings of the present invention.

FIG. 8 is a message flow diagram showing how the confederacy is adapted to allow each member device to act as a portal to other members' content in accordance with the teachings of the present invention.

FIG. 9 is a message flow diagram illustrating how data may be cached for some objects allowing for faster access in accordance with the teachings of the present invention.

FIG. 10 is a message flow diagram illustrating a manner by which the confederacy verifies that a member device is still active and on the network in accordance with the teachings of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

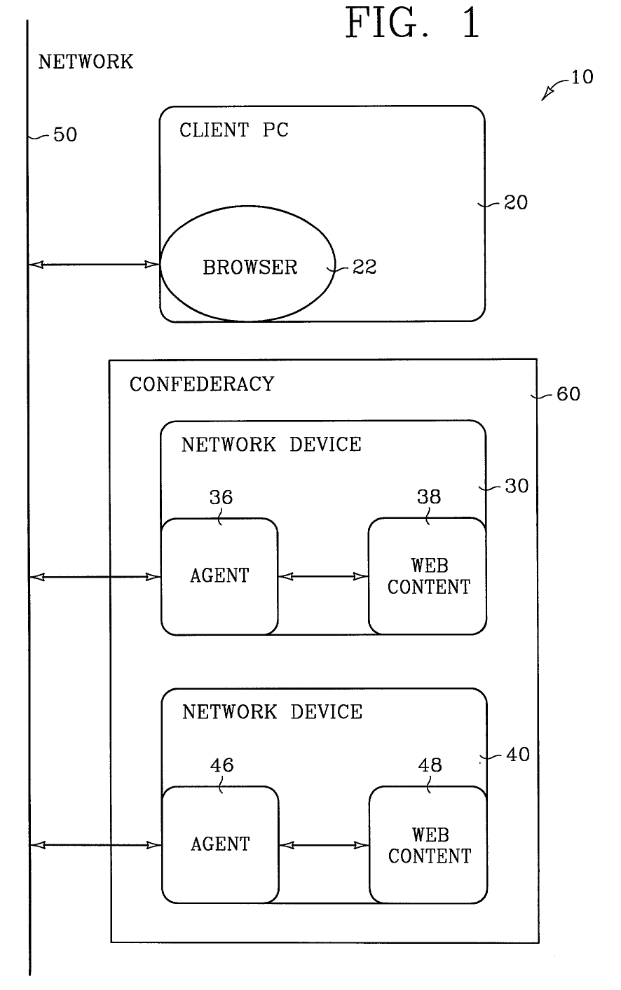

FIG. 1 is a block diagram of a system incorporating the teachings of the present invention. The inventive system 10 includes a client machine 20 adapted to communicate with plural devices, of which only two are shown 30 and 40, respectively, via a network 50. In the illustrative application, the network 50 is a private internal network or “intranet”. Nonetheless, the present invention is not limited to intranet applications. The present teachings may be implemented via wide area, public (e.g., Internet) and other networks. In addition, those skilled in the art will appreciate that the present teachings are not limited to wired networks. The invention lends itself to implementation via wireless (e.g., Bluetooth) networks as well as wired networks. Further, the network may be a peer-to-peer, client-server or other network topology.

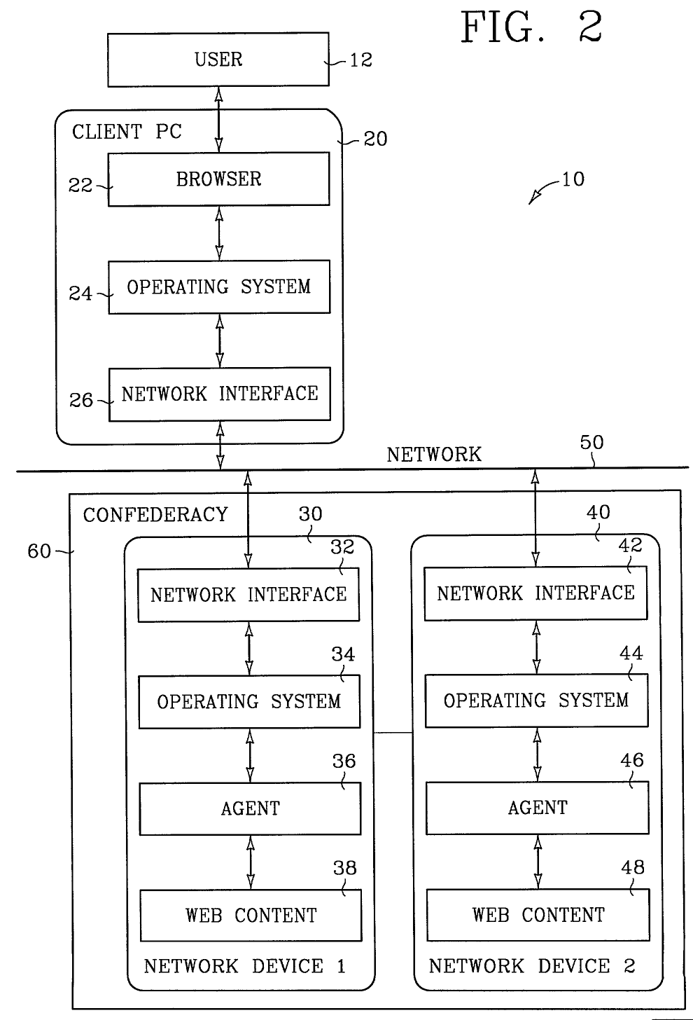

FIG. 2 is a generalized software block diagram for use with the system of FIG. 1 in accordance with the teachings of the present invention. As illustrated in FIGS. 1 and 2, a user (e.g., a systems administrator) 12 interfaces with the network via a browser 22 running on the client machine 20. The browser 22 may be a conventional web browser such as Internet Explorer™ or Netscape Navigator™. The browser 22 runs under an operating system (e.g. Windows NT by way of example) 24 and effects communication with the network 50 via a conventional network interface 26 such as an Ethernet adapter or other suitable network driver.

In accordance with the present teachings, each device 30, 40, etc. connected to the network 50 has a network interface 32, 42, etc. running under an operating system 34, 44, respectively. The network interfaces and the operating systems 34 and 44 are conventional and compatible with the interface 26 of the client machine 20. In accordance with the present teachings, an agent 36, 46 is effective to create a confederacy 60 among the devices 30, 40, respectively, connected to the network 50 and allows for access by the user 12 to web content 38 and 48, respectively, stored therein. Each agent may be implemented via an applet written in Java_{™}, Javascript_{™}, C, C⁺⁺, or other suitable programming or scripting language. The agent may be preinstalled on network devices or it may be stored on the client machine or on one or more network devices from which it is downloaded to new devices as they are added to the network 50.

The web content 38, 48 shown in FIGS. 1 and 2 may be conventional data stored in accordance with HTML, VRML, XML or other web protocol. Those skilled in the art will appreciate that the present invention is not limited to use in connection with web data. The teachings of the present invention may be used to access other resources data, software, hardware provided via the devices connected to the network 50 without departing from the scope of the present teachings.

As discussed more fully below and in accordance with the present teachings, the confederacy 60 created by the agents allow each device to be kept in sync with other devices in the confederacy. This allows the user 12 to browse to one device, e.g., 30, and see a view of the entire confederacy.

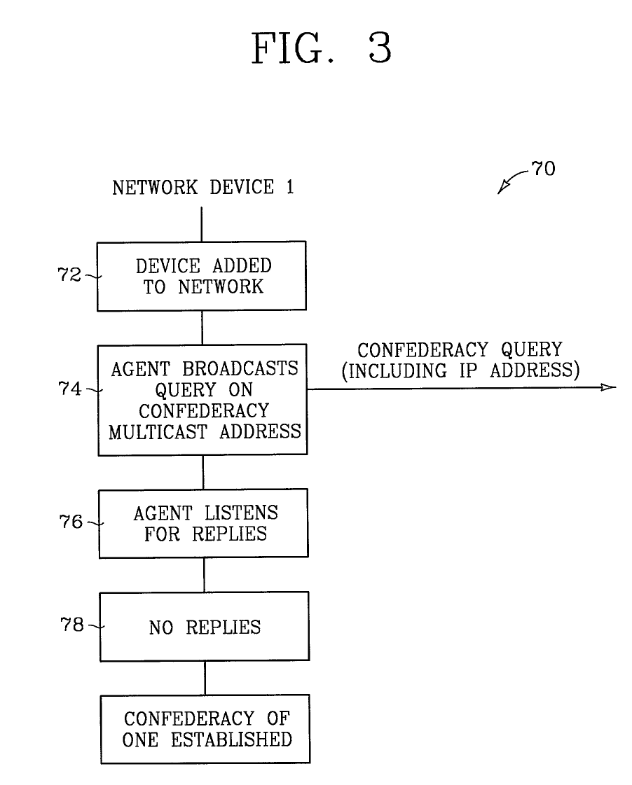

As discussed more fully below, FIGS. 3-10 are message flow diagrams illustrating the operation of the confederacy 60 in accordance with the teachings of the present invention. FIG. 3 is a message flow diagram showing the establishment of the confederacy in accordance with the teachings of the present invention. As shown in the diagram 70, the confederacy 60 is established when, at step 72, a device (device 30) is added to the network 50. Next, at step 74, the agent 36 on the device 30 broadcasts a query including its IP (Internet protocol) address over the confederacy multicast address on the network 50 and at step 76, the device listens for a reply to its confederacy query. Those skilled in the art will know that a multicast IP address may be obtained from the Internet Assigned Numbers Authority (IANA). If, at step 78, no replies are received, then a confederacy of one is established.

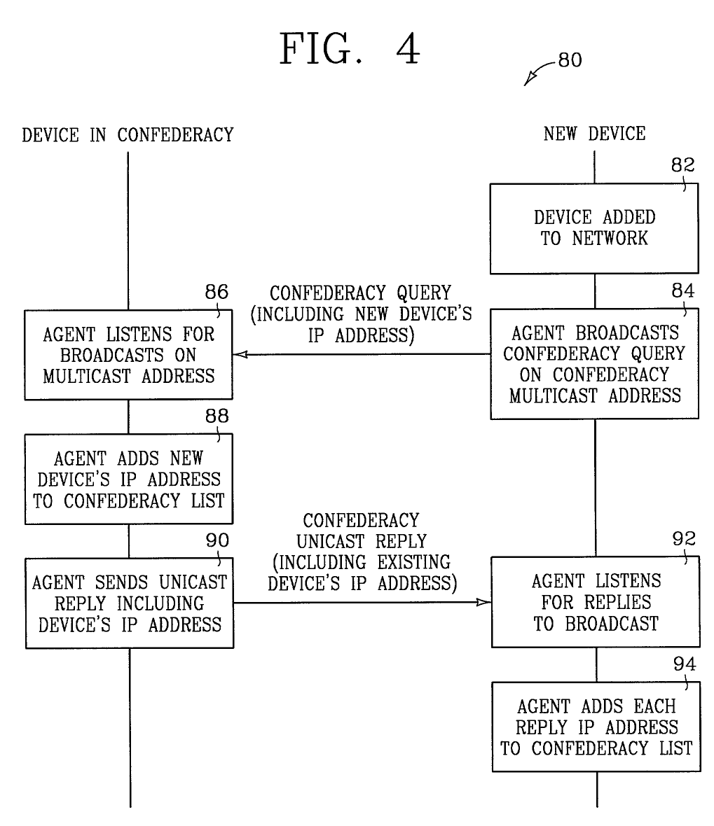

FIG. 4 is a message flow diagram illustrating a manner by which a device joins the confederacy in accordance with the teachings of the present invention. As shown in the diagram 80, at step 82, when a new device (e.g. 40) is added to the network, its agent 46 broadcasts a query including its IP address on the confederacy multicast address on the network and listens for replies (step 84). This confederacy query (including the new device IP address) is received by an agent (e.g. 36) on the confederacy (step 86) which at step 88 adds the new device IP address to the confederacy list. At step 90, the existing agent 36 sends a unicast reply including the existing device's IP address. At step 92, the new agent 46 receives the reply and at step 94, adds reply IP address to its confederacy list. At this point, the new device 40 has joined the confederacy 60. The new device 40 has the IP addresses for all members and the existing devices 30 have the IP address of the new device 40.

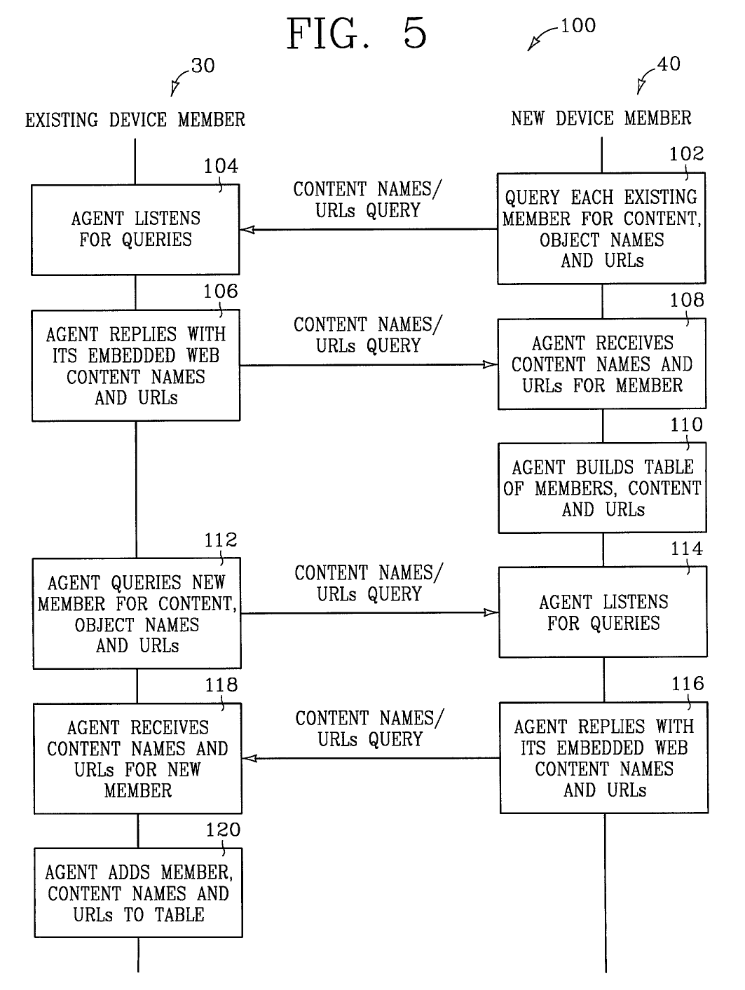

FIG. 5 is a message flow diagram showing how a consistent view of data stored on the network devices is created in accordance with the teachings of the present invention. At step 102, the new device 40 queries each existing member for content object names and their associated Universal Resource Locators (URLs). The existing devices are constantly listening and receive the content name/URL query (step 104). At step 106, a first existing agent 36 replies with its resource information, in this example, embedded web content names/URLs. At step 108, the agent of the new device 40 receives the content name/URL reply for the first agent and adds it to a table of members, content and URLs (step 110). At step 112, the first existing agent 36 in the confederacy sends a query to the new device member for its embedded web content names and URLs (112). The new device member agent (46) is always listening for queries (114). In addition, at step 116, the new agent 46 replies with its embedded web content names and URLs to each agent in the confederacy. At step 118, this list of object names and URLs is received by each agent and the information is added to its members, content and URLs table (step 120). At this point, the new device 40 has added each member and its content and URLs to its table. In addition, existing members have added the new device to their members, content and URLs table. Each device in the confederacy has a consistent view of the others.

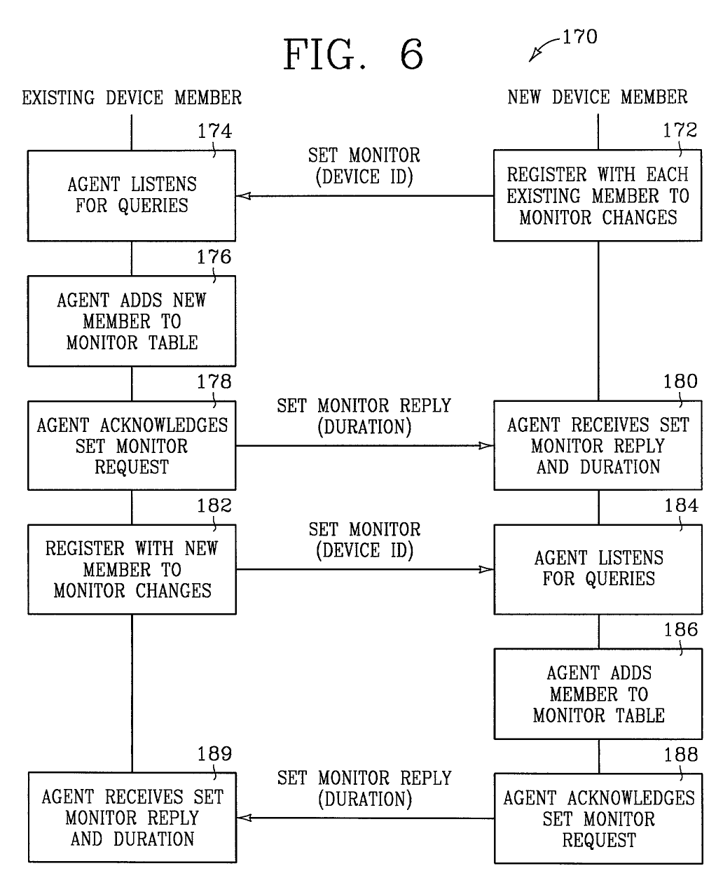

FIG. 6 is a message flow diagram illustrating the manner by which the confederacy allows members to monitor changes in other member's content. The diagram 170 of FIG. 6 shows how the members register to monitor changes in the other members' content. Thus, at step 172, a new device registers with each existing member to monitor changes in its resources and sends a ‘set monitor’ message with its IP address. This request is received by each agent (step 174). At step 176, each agent adds the new member to its monitor table and, at step 178, acknowledges the set monitor request by sending a ‘set monitor reply’ to the new device. The reply is received by the new device at step 180 along with other data, such as the duration of the monitor request, which may be sent by the existing device member.

At steps 182-189, steps 172-180 are repeated from the perspective of the existing members. That is, at step 182, each existing member registers with the new member to monitor changes. At step 184, the new member receives the ‘set monitor’ message with member ID and adds the member to its monitor table (step 186). At step 188, the new member then sends an acknowledgment in the nature of a ‘set monitor reply’. The reply is received by the existing agent at step 189.

Accordingly, as depicted in FIG. 6, in accordance with the present teachings, the new device has registered with each existing member to receive notice of object changes. In addition, the existing devices have registered with the new device to receive notice of object changes. When a change occurs such as an addition, deletion, or modification, the device will notify those registered. The device must re-register before the duration time expires or in accordance with other instructions provided in the ‘set monitor’ message.

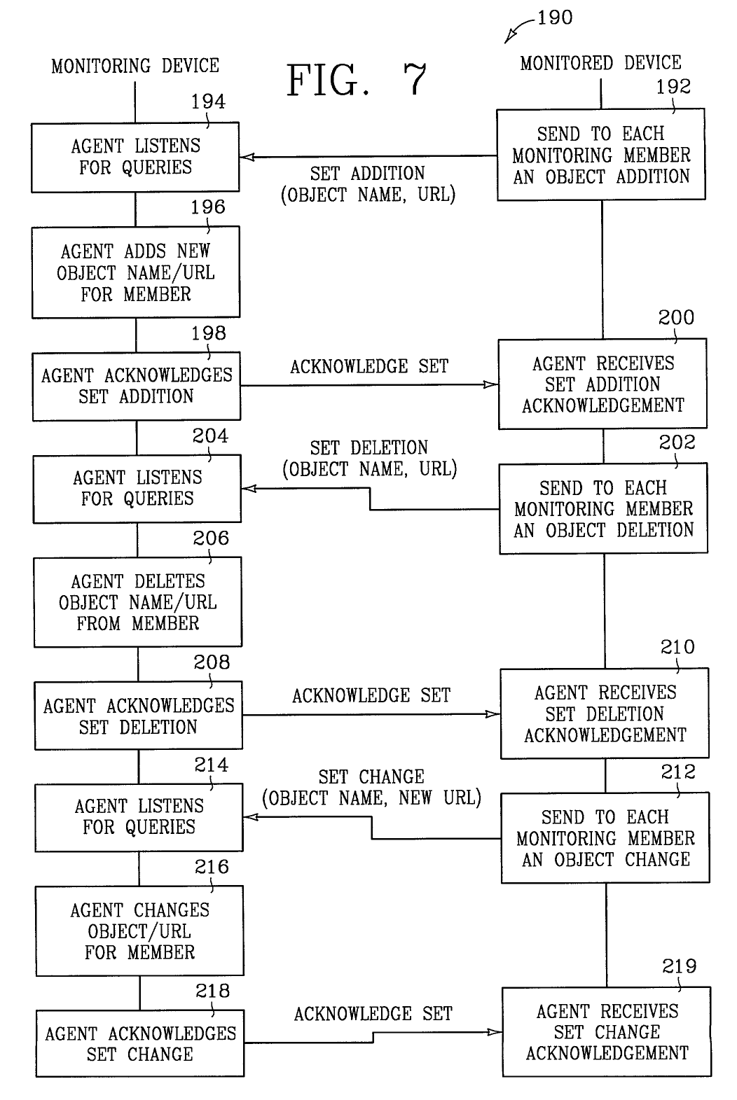

FIG. 7 is a message flow diagram showing how a monitored device in the confederacy indicates that a change in its stored data has occurred in accordance with the teachings of the present invention. When an object has changed, at step 192, a monitored device sends to each monitoring member an object addition message: ‘set addition’, along with the object name and its URL. At step 194, an agent at a monitoring device receives the message and, at step 196, adds the new object name and its URL for the member that sent the ‘set object’ message. Then, at step 198, the monitoring agent sends an acknowledgment which, at step 200, is received by the monitored device.

Likewise, when an object is deleted, at step 202, the monitored device sends to each monitoring member an object deletion message ‘set deletion’, including the object name and its URL. The object deletion message is received by the monitoring device (step 204), which deletes the object name and URL from its member table (step 206) and sends an acknowledgment.

Finally, at step 212, the monitored device sends an object change message ‘set change’ along with the name of the object and its new URL. This is received by each monitoring device (step 214), which then changes its member/object table accordingly (step 216) and sends an acknowledgment (step 218). Thus, the monitored device sends to each monitoring device a notice of an object change and, in response, the monitoring device changes its member/object table and sends an acknowledgment. Note that each device simultaneously acts as a monitoring device (monitoring all other devices in the confederacy) and as a monitored device (being monitored by all other devices in the confederacy). This allows the current state of the confederacy to be represented by any member device.

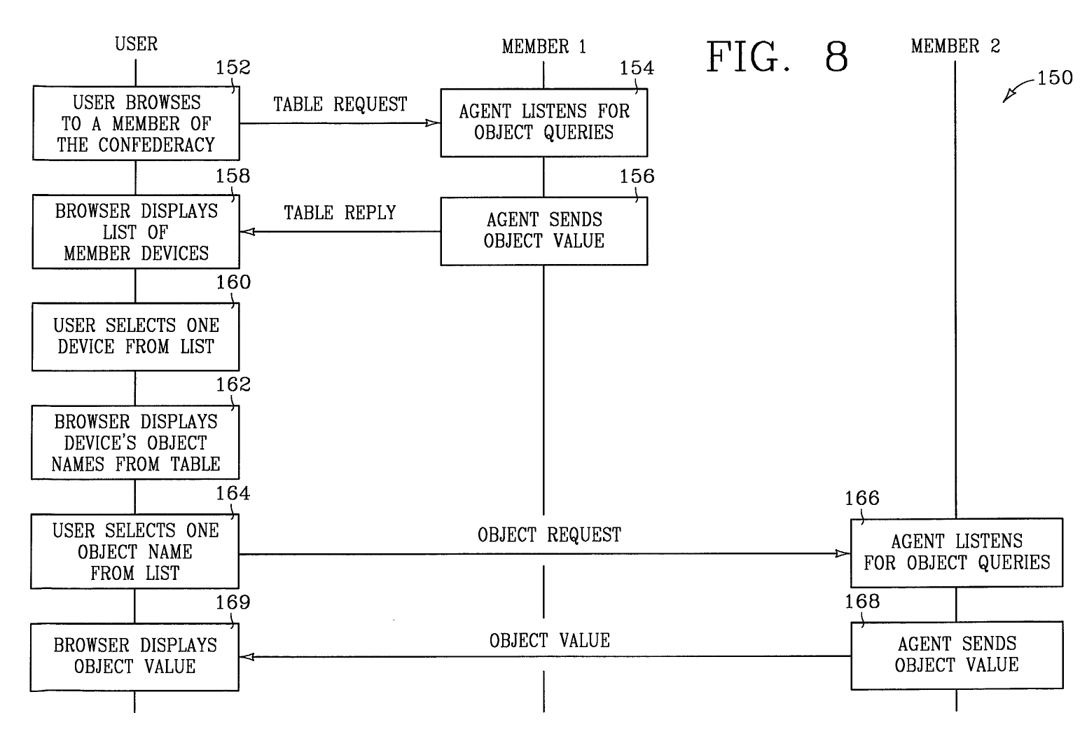

FIG. 8 is a message flow diagram showing how the confederacy is adapted to allow each member device to act as a portal to other members' content in accordance with the teachings of the present invention. As shown in the diagram 150, the present invention allows a user to browse to a member of the confederacy and see representations of all confederate members and their objects. A user can then select a member object name and the request is sent directly to the selected device. That is, at step 152, the user browses to a member of the confederacy and sends a table request. At step 154, a first agent listening for object queries receives the request and, at step 156, sends a list of member devices and their objects to the requesting agent. This information is received by the requesting agent and displayed at step 158. At step 160, the user selects one device from the list and at step 162, the browser displays object names from the table. At step 164, the user selects one object name from the list and the corresponding object request is sent to the device having the object (step 166). At step 168, the target agent sends the object value to the user and the user's browser displays the object value (step 169).

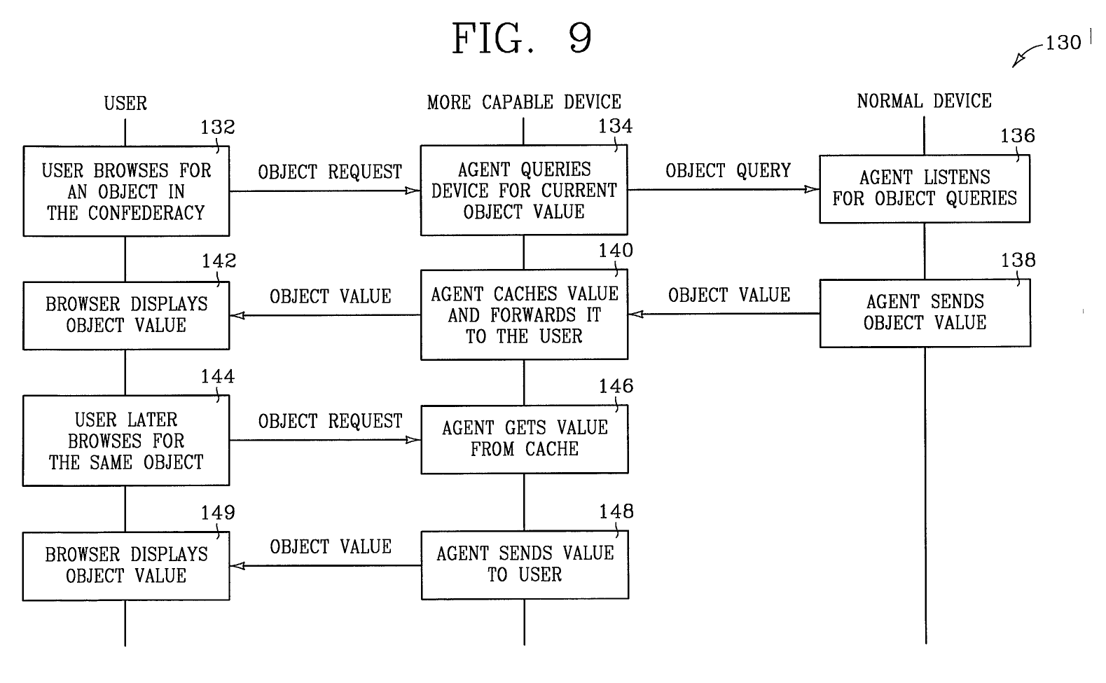

FIG. 9 is a message flow diagram illustrating how data may be cached for some objects allowing for faster access in accordance with the teachings of the present invention. The message flow diagram 130 of FIG. 9 shows an optional functionality by which, at step 132, a user browses for an object in the confederacy. In response, an object request is sent to a confederate device, which preferably is fast and has a large memory. At step 134, this receiving agent, in turn, sends the object query to the device having the object. At step 136, the destination agent receives the object request and, at step 138, sends the object value to the caching agent. At step 140, the caching agent sends the object to the user and the user's browser 22 (FIG. 1) displays the object and its associated value(s). If, at a later time, the user browses for the same object (step 144), the object request is received by the caching agent and retrieved from cache (step 146). At step 148, the caching agent sends the object value to the user and it is displayed, at step 149, in the usual manner. Those skilled in the art will appreciate that cached values must be refreshed before they expire.

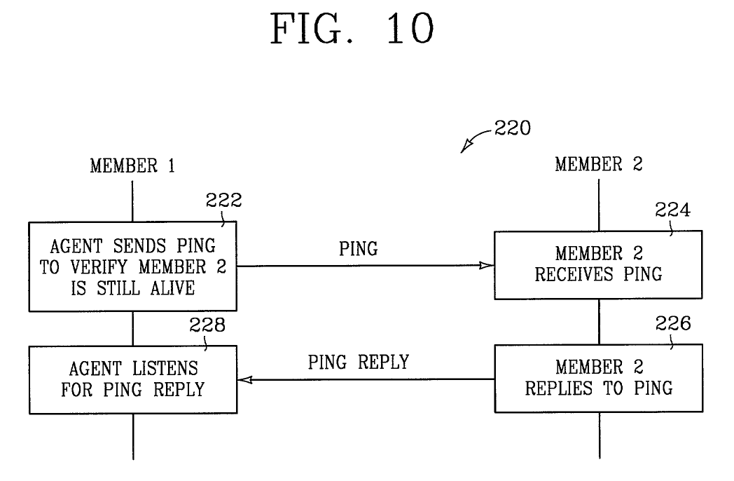

FIG. 10 is a message flow diagram illustrating a manner by which the confederacy verifies that a member device is still active and on the network in accordance with the teachings of the present invention. As shown in the diagram 220, if a monitoring device fails to send an acknowledgment to a Set command, fails to acknowledge a Monitor command, fails to re-initialize its monitor relationship within the duration time limit, or fails in some other manner specified by the administrator, any member may send a Ping to the other to verify that it is still alive (i.e., active) and on the network (step 222). If the member is alive, then at step 224, the ping is received and, at step 226, it sends a ping reply. If it does not reply, it is removed from the monitoring table and the confederacy table.

Thus, the invention provides a method, inter alia, to:

1. Create a confederacy of preferably web-enabled devices, allowing new devices to join.

2. Integrate all embedded (web) content from all members of the confederacy into a consistent view of all members.

3. Optionally, cache values for some objects to speed object retrieval.

4. Allow each member to act as a portal to all other members' web content.

5. Allow members to register to monitor changes in embedded web content in all other members in the confederacy.

6. Allow the monitored device to indicate to the monitoring device that an embedded web object has been added, deleted or changed.

7. Allow the monitoring device to acknowledge to the monitored device that an object addition, deletion or change has been received.

8. Allow devices to periodically “ping” other members to verify that they are still up on the network.

Thus, the present invention has been described herein with reference to a particular embodiment for a particular application. Those having ordinary skill in the art and access to the present teachings will recognize additional modifications, applications and embodiments within the scope thereof. For example, RFC # 2186, Internet Cache Protocol (ICP), version 2, from the IETF Network Working Group, and Internet Draft (Work in Progress), Hyper Text Caching Protocol (HTCP/0.0), by Vixie and Wessels, are a standard protocol and draft protocol for discovering HTTP origin servers and HTTP caches of information. In the preferred embodiment, the invention makes use of portions of those protocols to perform its functions. However, the application of portions of those protocols in this invention is unique. A completely separate protocol could be designed for use in implementing this invention without departing from the scope thereof.

It is therefore intended by the appended claims to cover any and all such applications, modifications and embodiments within the scope of the present invention.

What is claimed is:

1. A confederacy comprising:
a network;
a plurality of devices coupled via said network, at least one of said devices having a resource; and
means for automatically effecting communication with respect to said resource between said device having said resource and at least one other of said devices coupled via said network.

2. The invention of claim 1 wherein said network is an intranet.

3. The invention of claim 1 wherein said resource is embedded web content.

4. The invention of claim 1 said means for automatically effecting communication being an agent residing on at least one of said devices.

5. The invention of claim 4 wherein said agent resides on said device having said resource.

6. The invention of claim 5 further including an agent running on each device on said network.

7. The invention of claim 6 wherein each agent running on each of said devices on said network is implemented in software.

8. The invention of claim 7 wherein said agents include code for establishing said confederacy.

9. The invention of claim 8 wherein said agents include code for joining said confederacy.

10. The invention of claim 8 wherein said agents include code for providing a consistent view of web content embedded on at least one of said devices.

11. The invention of claim 8 wherein at least one device includes memory for caching an object value from a device in said confederacy.

12. The invention of claim 8 wherein at least one of said agents includes code for allowing each member to act as a portal.

13. The invention of claim 8 wherein said agents include code for monitoring changes at said other devices in said confederacy.

14. The invention of claim 8 wherein said agent includes code for verifying that a member device is active and in the confederacy.

15. A confederacy comprising:
a network;
a plurality of devices coupled via said network; and
a software agent running on each device for establishing a confederacy therebetween.

16. The invention of claim 15 wherein said network is an intranet.

17. The invention of claim 15 wherein each agent running on each of said devices on said network is implemented in software.

18. The invention of claim 15 wherein said agents include code for joining said confederacy.

19. The invention of claim 18 wherein said agents include code for providing a consistent view of web content embedded on at least one of said devices.

20. The invention of claim 18 wherein at least one device includes memory for caching an object value from a device in said confederacy.

21. The invention of claim 18 wherein at least one of said agents includes code for allowing each member to act as a portal.

22. The invention of claim 18 wherein said agents include code for monitoring changes at said other devices in said confederacy.

23. The invention of claim 18 wherein said agent includes code for verifying that a member device is active and in the confederacy.

24. A method for establishing a confederacy including the steps of:
coupling a plurality of devices via a network, at least one of said devices having a resource and
automatically effecting communication with respect to said resource between said device having said resource and at least one other of said devices coupled via said network.
